(19) United States
(12) Patent Application Publication
(10) Pub. No.: US 2006/0038740 A1
(43) Pub. Date: Feb. 23, 2006

(54) Ghost image elimination in multi display device

(76) Inventors: Won-Gab Jung, Daegu (KR); Jun-Hyoung Myoung, Seoul (KR)

Correspondence Address: LAW OFFICE OF MONICA H CHOI, P O BOX 3424, DUBLIN, OH, 430160204, US

(21) Appl. No.: 11/198,509

(22) Filed: Aug. 5, 2005

(30) Foreign Application Priority Data
Aug. 17, 2004 (KR) 2004-64660

(51) Int. Cl. G09G 5/00

(52) U.S. Cl. 345/1.1

(57) ABSTRACT

A multi display device includes a first display panel, a second display panel, and a display control circuit for driving the first display panel for a predetermined number of vertical synchronization pulses. The display control circuit includes a ghost image elimination circuit for driving the second display panel to eliminate a ghost image thereon while de-activating the first display panel after the predetermined number of vertical synchronization pulses.

### BACKGROUND OF THE INVENTION

This application claims priority under 35 USC § 119 to Korean Patent Application No. 2004-64660, filed on Aug. 17, 2004 in the Korean Intellectual Property Office (KIPO), the entire contents of which are hereby incorporated by reference.

1. Field of the Invention

The present invention relates generally to display panels, and more particularly to eliminating a ghost image in a display panel when another display panel of a multi display device is activated.

2. Description of the Related Art

A multi display device generally includes a main display panel that displays a larger amount of images and characters and a sub display panel that displays a smaller amount of images and characters. For example, in a mobile terminal such as a foldable mobile phone, the main display panel is positioned in an interior portion of the foldable mobile phone to display a phone number of an incoming call, a dynamic image, etc. On the other hand, the sub display panel is positioned in an exterior portion of the foldable mobile phone to display time information, a battery level, etc.

A camera module within the mobile terminal is desired to have high performance especially when displaying a moving picture. Thus, a thin film transistor (TFT) liquid crystal display panel is used for the main display panel with relatively high response speed, high resolution, and high color reproducibility. On the other hand, a super twisted nematic (STN) liquid crystal display panel or the TFT liquid crystal display panel used for the sub display panel has relatively lower resolution and lower color reproducibility.

Such a dual display device may provide user convenience with high device performance. However, when the two liquid crystal display panels are driven independently, a volume of the mobile terminal is increased, and separate driving circuits for the liquid crystal display panels may result in higher cost and increased power consumption.

When a common driving circuit is used for the two display panels to separately control the resolution of both display panels, the volume of the device may be reduced. However, such separate resolution control of both display panels may require an expensive driver chip, and a small size portable device may still be hard to achieve. When the main display panel and the sub display panel need not be concurrently driven to display images, a common driving circuit for controlling the resolution of the main display panel may be shared for driving the sub display panel.

To display an image on the main display panel, only the main display panel is driven and the sub display panel is powered off. Similarly, when an image is displayed on the sub display panel, only the sub display panel is driven and the main display panel is powered off. The use of the common driver chip may lower costs but may induce noise and increase power consumption from increased parasitic wiring capacitance.

To overcome such problems, the main display panel and the sub display panel have separate row lines (i.e., scan lines), while sharing common column lines (i.e., source lines). In a TFT display panel, a row line is coupled to a gate terminal of a cell transistor of a pixel, and a column line is coupled to a source terminal of the cell transistor of the pixel.

FIG. 1 is a schematic view illustrating a dual display device with one driver chip. Referring to FIG. 1, the dual display device includes a sub display panel 110, a main display panel 130, a driver integrated chip (IC) 140, glass substrates 101 and 102, and a flexible printed circuit board (FPCB) 120. The one driver IC 140 is mounted on the glass substrate 102 via a chip-on-glass (COG) manner or using amorphous silicon gate (ASG) for driving both display panels 110 and 130. The main display panel 130 and the driver IC 140 are mounted on one glass substrate 102, and the sub display panel 110 is mounted on the other glass substrate 101. The glass substrates 102 and 101 are coupled through the FPCB 120.

To drive both the main display panel 130 and the sub display panel 110, source lines from the driver chip 140 are shared between the main display panel 130 and the sub display panel 110. The driver chip 140 drives appropriate scan lines and source lines depending on whether an image is displayed on the main display panel 130 or on the sub display panel 110.

A backlight is used in a liquid crystal display panel as light transmittance of the liquid crystal display panel is adjusted. In a multi display device, multiple display panels share a common backlight to reduce an overall dimension of the display device and lower costs. For example, in the foldable mobile terminal having the two display panels, the backlight unit is disposed in a folding part interposed between the main display panel and the sub display panel.

FIG. 2 is a schematic view illustrating a dual display device with a common backlight. Elements in FIGS. 1 and 2 having the same reference numerals refer to similar elements. As described in FIG. 1, the glass substrate 101 with the sub display panel 110 is coupled to the glass substrate 102 with the main display panel 130 through the FPCB 120. In FIG. 2, the sub display panel 110 is rotated 180 degrees so that a rear face of the sub display panel 110 opposes a rear face of the main display panel 130. A backlight 150 is interposed between the rear of the main display panel 130 and the rear of the sub display panel 110. The backlight 150 is a bidirectional light-emitting device for directing light toward both the main display panel 130 and the sub display panel 110.

Two display panels sharing a single driver chip and a single backlight may exhibit the following problem. Because outputs on shared source lines from the driver chip are commonly used for the main display panel and the sub display panel, leakage current may flow through the sub display panel when the main display panel is activated. Such leakage current through the sub display panel may result in an undesired ghost image appearing on the sub display panel.

When the display panels use separate backlights and only the backlight for the main display panel is turned on, the ghost image would not appear on the sub display panel. However, when a common backlight is shared by the main and sub display panels, the light is also directed toward the sub display panel even when only the main display panel is activated. Therefore, a ghost image is generated by the leakage current through the sub display panel to provide a distorted image to a viewer.

### SUMMARY OF THE INVENTION

Accordingly, a multi display device of embodiments of the present invention has elimination of such an undesired ghost image.

A multi display device according to an embodiment of the present invention includes a first display panel, a second display panel, and a display control circuit for driving the first display panel for a predetermined number of vertical synchronization pulses. In addition, the display control circuit includes a ghost image elimination circuit for driving the second display panel to eliminate a ghost image thereon while de-activating the first display panel after the predetermined number of vertical synchronization pulses.

In another embodiment of the present invention, the multi display device includes first respective scan lines coupled to the first display panel from the display control circuit, and includes second respective scan lines separate from the first respective scan lines and coupled to the second display panel from the display control circuit. In that case, the first respective scan lines are de-activated after the predetermined number of vertical synchronization pulses.

In a further embodiment of the present invention, the multi display device includes source lines coupled to the first display panel with a sub-set of the source lines being shared with the second display panel.

In an example embodiment of the present invention, each vertical synchronization pulse corresponds to a respective frame period. The second display panel is driven for one frame period after the predetermined number of vertical synchronization pulses. The second display panel is driven with one of a black image, a white image, a grey image, or a still image.

Such a multi display device may be advantageously used as part of a foldable mobile terminal with the first display panel being disposed on an inner surface of the foldable mobile terminal and with the second display panel being disposed on an outer surface of the foldable mobile terminal.

### BRIEF DESCRIPTION OF THE DRAWINGS

The above and other features and advantages of the present invention will become more apparent when described in detailed exemplary embodiments thereof with reference to the attached drawings in which:

FIG. 1 is a schematic view of a conventional dual display device with one driver chip;

FIG. 2 is a schematic view of a conventional dual display device using a common backlight unit;

FIG. 3 is a block diagram of a multi display device according to an example embodiment of the present invention;

FIG. 4 is a block diagram of a ghost image elimination circuit of FIG. 3, according to an example embodiment of the present invention;

FIG. 5 is a timing diagram of signals during operation of the multi display device of FIG. 3, according to an example embodiment of the present invention; and

FIGS. 6A and 6B are perspective views of a mobile communication terminal incorporating the multi display device of FIG. 3, according to an example embodiment of the present invention.

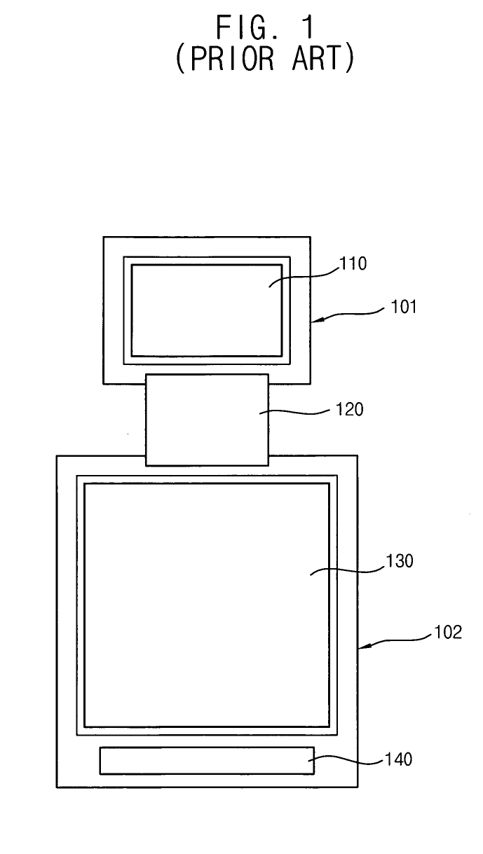

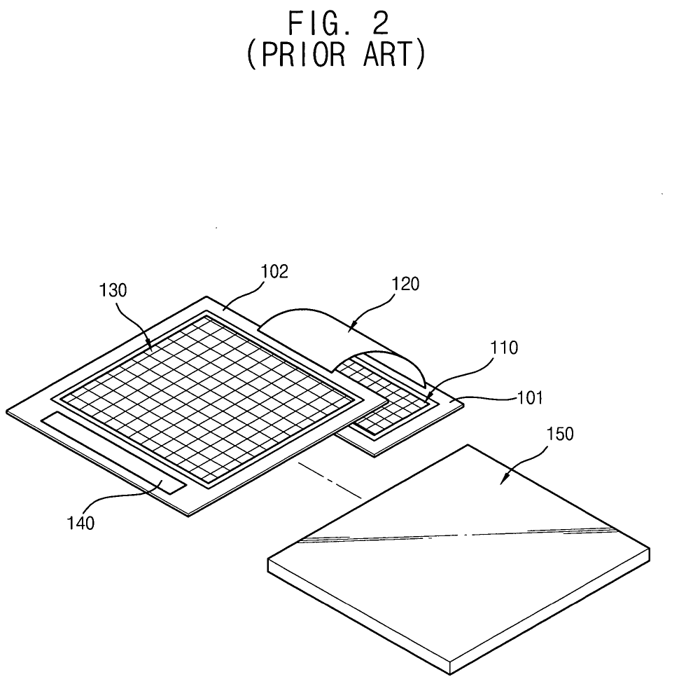

The figures referred to herein are drawn for clarity of illustration and are not necessarily drawn to scale. Elements having the same reference number in FIGS. 1, 2, 3, 4, 5, 6A, and 6B refer to elements having similar structure and/or function.

### DETAILED DESCRIPTION OF THE INVENTION

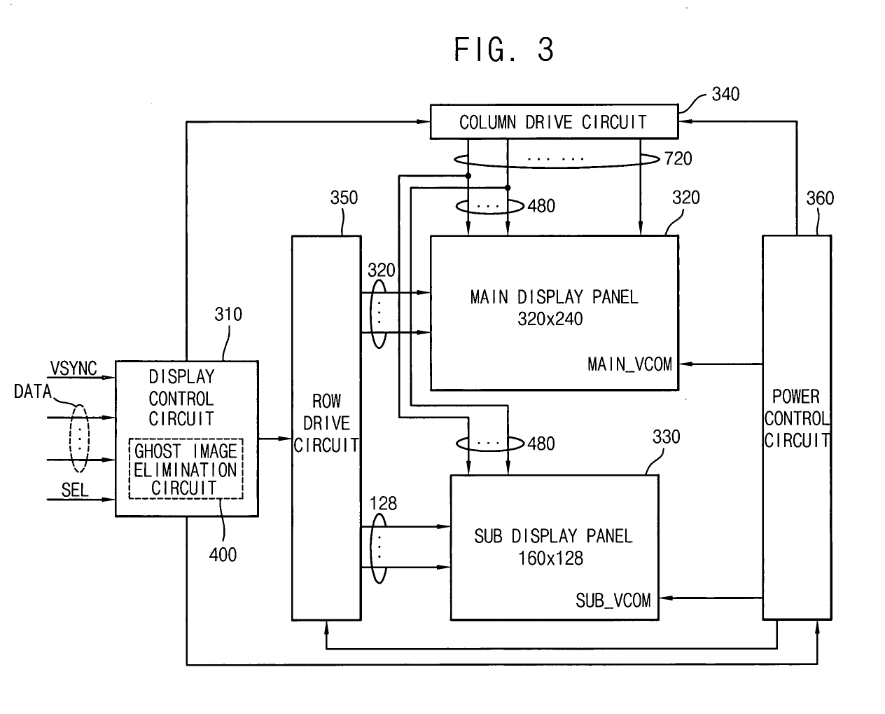

FIG. 3 is a block diagram of a multi display device according to an example embodiment of the present invention. In FIG. 3, the multi display device has a dual display configuration. Alternatively, the multi display device according to an example embodiment of the present invention may have more than two display panels.

The multi display device of FIG. 3 includes a main display panel 320, a sub display panel 330, a display control circuit 310, and a power control circuit 360. The multi display device of FIG. 3 further includes a column drive circuit 340 for driving source lines and a row drive circuit 350 for driving gate lines, for the main display panel 320 and the sub display panel 330.

The main display panel 320 and the sub display panel 330 are each a thin film transistor (TFT) liquid crystal display panel or a super-twisted nematic (STN) liquid crystal display panel, in an example embodiment of the present invention. When the main display panel 320 and the sub display panel 330 are each a TFT liquid crystal display panel, the column drive circuit 340 may also be referred to as a source drive circuit (or a data drive circuit) and the row drive circuits 350 as a gate drive circuit. Example embodiments of the present invention are especially applicable when the main display panel 320 and the sub display panel 330 share a common back-light.

In FIG. 3, the main display panel 320 has an example resolution of about 320×240, and the sub display panel 330 has an example resolution of about 160×128. The row drive circuit 350 outputs row drive (i.e., scan line) signals on 320 row (i.e., scan) lines for the main display panel 320. Additionally, the row drive circuit 350 outputs row drive (i.e., scan line) signals on 160 row lines for the sub display panel 330. In one embodiment of the present invention, the 320 scan lines for the main display panel 320 are separate from the 160 scan lines for the sub display panel 330. Therefore, the row drive circuit 350 drives a total of 480 scan lines.

The column drive circuit 340 outputs a column drive (i.e., source line) signals on 720 column (i.e., source) lines for the main display panel 320. Since a pixel generally includes three sub pixels for R (red), G (green) and B (blue), the 720 column lines are required to scan all of the sub pixels (i.e., 240×3=720). Among the 720 column lines of the main display panel 320, 384 column lines (128×3=384) are used as the column lines for the sub display panel 330. Namely, the 384 column lines are shared by the main display panel 320 and the sub display panel 330.

The column drive circuit 340 and the row drive circuit 350 have various components optimized for each type of display panel. For example, the column drive circuit 340 may include a frame memory, a shift register, a line latch, a level shifter, a source driver, etc.

The display control circuit 310 receives from an external source, image data DATA, a vertical synchronization signal VSYNC, and a horizontal synchronization signal HSYNC, to control the row drive circuit 350, the column drive circuit 340, and the power control circuit 360, in response to such data/signals. The display control circuit 310 also receives a select signal SEL for selecting either the main display panel 320 or the sub display panel 330 as an activated display panel. The display control circuit 310 determines whether the image data DATA is displayed on the main display panel 320 or on the sub display panel 330 that is the activated display panel as indicated by the select signal SEL.

The power control circuit 360 provides a respective common electrode voltage MAIN_VCOM to the main display panel 320 and a respective common electrode voltage SUB_VCOM to the sub display panel 330. The power control circuit 360 also provides respective voltages to the column drive circuit 340 and row drive circuit 350 upon control by the display control circuit 310.

The display control circuit 310 further includes a ghost image elimination circuit 400 to eliminate a ghost image on the sub display panel 330 caused by driving the main display panel 320. Generally, driving of a first display panel is periodically interrupted by the ghost image elimination circuit 400 to eliminate a ghost image on remaining display panels caused by driving the first display panel.

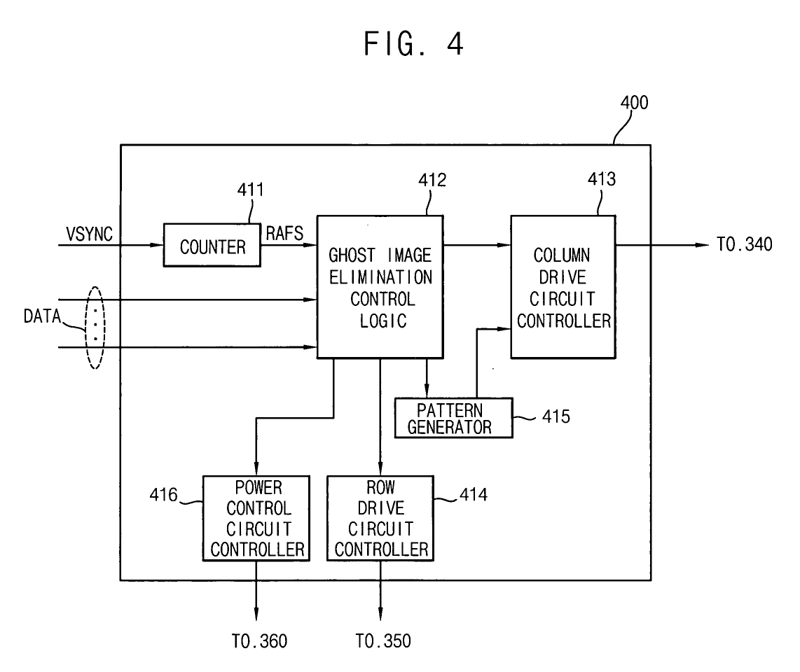

FIG. 4 is a block diagram of the ghost image elimination circuit 400 of FIG. 3, in one embodiment of the present invention. Referring to FIG. 4, the ghost image elimination circuit 400 includes a counter 411, a ghost image elimination control logic 412, a column drive circuit controller 413, a row drive circuit controller 414, a power control circuit controller 416, and a pattern generator 415.

The counter 411 counts the number of vertical synchronization pulses of the vertical synchronization signal VSYNC to generate a control signal RAFS (Remove Afterimage Signal). For example, the counter 411 activates the control signal RAFS every 60th vertical synchronization pulses of the signal VSYNC. Alternatively, the counter 411 activates the control signal RAFS every 30th vertical synchronization pulses of the signal VSYNC.

The control signal RAFS from the counter 411 is sent to the ghost image elimination control logic 412. When the control signal RAFS is activated, a display panel that is considered activated is switched to another display panel. For example, when the row lines of the main display panel 320 were activated, the row lines of the main display panel 320 are deactivated, and the row lines of the sub display panel 330 become activated instead. In addition, when the column lines of the main display panel 320 were activated, the column lines of the main display panel 320 are deactivated, and the column lines of the sub display panel 330 become activated instead.

Similarly, the ghost image elimination control logic 412 uses the power control circuit controller 416 to control the common electrode voltage of the display panel that is to be switched on or off. The pattern generator 415 generates an image pattern to be displayed on the sub display panel 330 for eliminating the ghost image thereon in response to the activated control signal RAFS. The image pattern generated by the pattern generator 415 is provided to the column drive circuit 340 via the column drive circuit controller 413.

The image pattern may correspond to a black image, a white image, or a grey image, in one embodiment of the present invention. Such images individually are known to one of ordinary skill in the art. Alternatively, when the counter 411 activates the control signal RAFS with relatively high frequency, for example, ten times per sixty vertical synchronization pulses of the signal VSYNC, the image pattern may correspond to a certain logo image. However, when the logo image is used to eliminate the ghost image, a refresh rate of the activated main display panel may be lowered, such that a quality of the image displayed on the main display panel may be degraded.

When a still image such as a logo image is used for the ghost image elimination, a memory may be needed to store the predetermined still image. Alternatively, the image pattern may be provided from an external image source, thereby removing the need for the memory. For example, the ghost image elimination circuit 400 may request an input of a predetermined image pattern to the external image source in response to the activated control signal RAFS. In that case, the image data DATA for the predetermined image pattern is provided to the column drive circuit 340 via the column drive circuit controller 413.

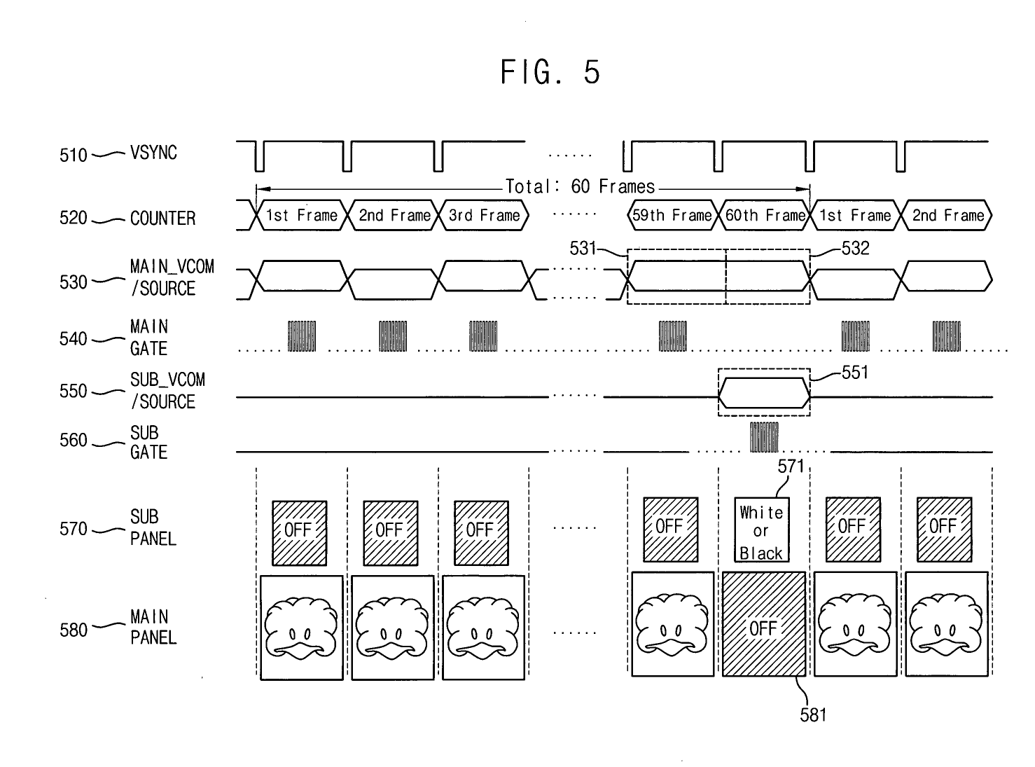

FIG. 5 is a timing diagram of signals during operation of the multi display device of FIG. 3 for ghost image elimination. The VSYNC signal 510 represents a vertical synchronization signal applied to the display control circuit 310. The VSYNC signal 510 is input to the ghost image elimination circuit 400 of the display control circuit 310 such that the counter 411 of the ghost image elimination circuit 400 counts the number of vertical synchronization pulses in the VSYNC signal 510. In one embodiment of the present invention, each vertical synchronization pulse corresponds to one frame period such that the counter 520 in FIG. 5 represents a counting of the frame periods.

In FIG. 5, the MAIN_VCOM/SOURCE signal 530 represents a voltage difference between a common electrode voltage MAIN_VCOM of the main display panel 320 and a voltage level of a column drive signal SOURCE of the column drive circuit 340 for the main display panel 320. In the TFT display panel, the MAIN_VCOM/SOURCE signal 530 corresponds to a voltage difference between a source electrode of a cell transistor and a common electrode of the pixel.

To prevent deterioration of the pixel in the display panel, the polarity of a voltage applied to the pixel may be periodically inverted, which is referred to as a polarity inversion method. The polarity inversion method may be one of frame inversion, line inversion, column inversion, and dot inversion. In FIG. 5, the polarity of the voltage is inverted every frame period (frame inversion).

A main gate signal 540 shows output (i.e., scan) signals from the row drive circuit 350 for the main display panel 320. Although most parts of the main gate signals are omitted for brevity, the main gate signal 540 corresponding to the vertical resolution (i.e., number of pixels in one column) of the main display panel 320 are outputted every frame period to sequentially activate a scan line of the main display panel 320 one by one.

A SUB_VCOM/SOURCE signal 550 of FIG. 5 shows a voltage difference between a common electrode voltage SUB_VCOM of the sub display panel 330 and a voltage level of a column drive signal SOURCE of the column drive circuit 340 for the sub display panel 330. Similarly, in the TFT display panel, the SUB_VCOM/SOURCE signal 550 corresponds to a voltage difference between the source electrode of the cell transistor and the common electrode of the pixel. As shown in FIG. 5, for every 60th frame period, the SUB_VCOM 551 is applied to the sub display panel 330 and image data is applied to column (i.e., source) lines of the sub display panel 330.

A sub gate signal 560 shows output (i.e., scan) signals from the row drive circuit 350 for the sub display panel 330. Although most parts of the sub gate signals 560 are omitted for brevity, the sub gate signals 560 corresponding to the vertical resolution (i.e., number of pixels in one column) of the sub display panel 330 are activated during every 60th frame period to sequentially activate a scan line of the sub display panel 330 one by one.

When the main display panel 320 is activated to display an image, most of the vertical synchronization signals are used to drive the main display panel 320. As shown in the MAIN_VCOM/SOURCE signal 530 of FIG. 5, the vertical synchronization signals are used to drive the main display panel 320 from a first frame to a 59th frame.

However, when the counter 411 periodically activates the control signal RAFS, the ghost image elimination control logic 412 controls the row drive circuit controller 414 to deactivate the row drive (i.e., scan line) signals for the main display panel 320 from the row drive circuit 350. Further, the ghost image elimination control logic 412 may control the power control circuit controller 416 to interrupt an output of the common electrode voltage MAIN_VCOM for the main display panel 320 from the power control circuit 360.

Alternatively, the ghost image elimination control logic 412 controls the power control circuit controller 416 to maintain an output of the common electrode voltage MAIN_VCOM for the main display panel 320 of the power control circuit 360 at a voltage level of an immediately previous frame. In this case, the main display panel 320 preserves an image of the immediately previous frame during a frame when the main display panel 320 is switched to an off (de-activated) state. In FIG. 5, the MAIN_VCOM/SOURCE signal 531 at the 59th frame period is maintained as the MAIN_VCOM/SOURCE signal 532 during the 60th frame period.

Additionally, the image pattern generated by the pattern generator 415 is output to the sub display panel 330 via the column (i.e., source) lines for the sub display panel 330 to eliminate the ghost image thereon. As shown in the SUB_VCOM/SOURCE signal 551 of FIG. 5, the SUB_VCOM/SOURCE signal 551 for the sub display panel 330 is outputted during the 60th frame period.

The same effect of ghost image elimination may also be achieved from external control of the display control circuit in an alternative embodiment of the present invention. The external control signals such as VSYNC, HSYNC, DATA, SEL, etc., provided to the display control circuit 310 shown in FIG. 3 may be controlled by an external device such that the ghost image may be eliminated.

That is, a display panel that is currently being driven may be temporarily switched off by a predetermined period of time based on the counted vertical synchronization signals, and the image pattern for eliminating the ghost image may be used to eliminate the ghost image on another display panel. For example, the external device counts the number of vertical synchronization signals VSYNC, and transmits the image pattern as the DATA signal to either the main display panel 320 or the sub display panel 330 that is selected by the SEL signal.

The above method may be implemented using software and/or hardware of the external device for controlling the multi display device for a compact design of the ghost image elimination circuit 400. The external device may include a central processing unit (CPU), especially a micro processing unit (MPU), etc.

It is very well known in the art that a system module may be easily combined with other various components and functions. Therefore, it will be understood that a portion of elements according to example embodiments of the present invention may be combined to one group. Functions of example embodiments of the present invention may be implemented using a combination of sequential instructions, i.e., a program code for driving a programmable device. Alternatively, functions may be implemented in a circuit configured to perform the same or similar functions.

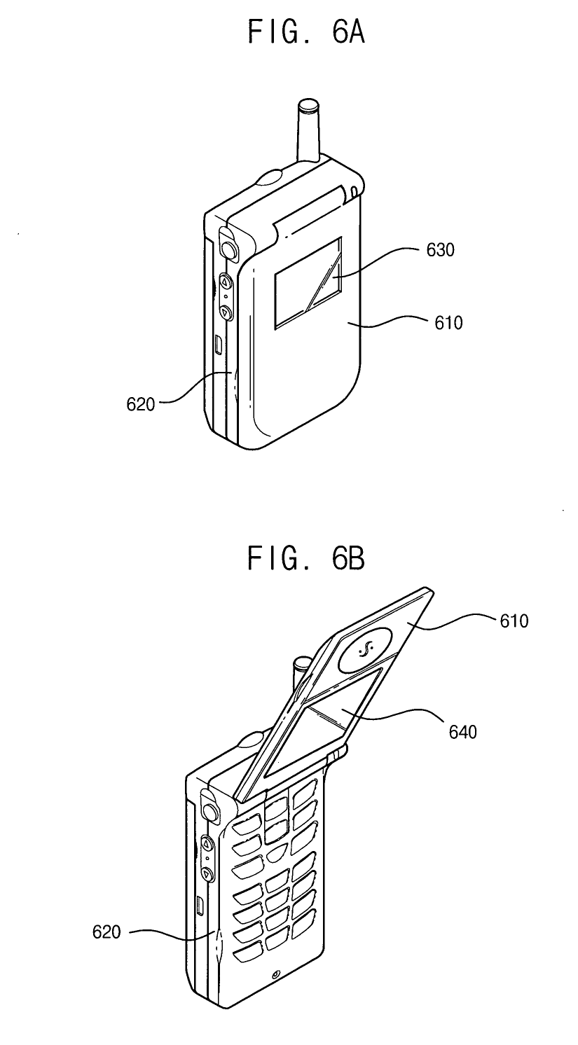

FIGS. 6A and 6B are perspective views illustrating a mobile communication terminal incorporating the multi display device of FIG. 3 according to an example embodiment of the present invention. The mobile communication terminal includes a folding part 610 and a body part 620, wherein the folding part 610 is foldable (or rotatable) relative to the body part 620.

The folding part 610 is in a closed position as shown in FIG. 6A (i.e., the mobile phone is folded), and a sub display panel 630 is mounted on an outer surface of the folding part 610. In FIG. 6B, the folding part 610 is in an open position (i.e., the mobile phone is unfolded), and a main display panel 640 is mounted on an inner surface of the folding part 610.

As shown in FIGS. 6A and 6B, the main display panel 640 and the sub display panel 630 are disposed on the folding part 610, opposite to each other. A common backlight is disposed between the main display panel 640 and sub display panel 630.

In a foldable mobile phone, when the folding part 610 is in the closed position as shown in FIG. 6A, the main display panel 640 is turned off, and the sub display panel 630 is turned on. Because the mobile phone is folded, the user cannot view the main display panel so that the ghost image caused by the leakage current through the sub display panel is of no concern.

Conversely, when the folding part 610 is in the open position as shown in FIG. 6B, the main display panel 640 is turned on and the sub display panel 630 is turned off. In this case, a ghost image may appear in the sub display panel 630 because the backlight is shared by the sub display panel 630. Therefore, the ghost image elimination circuit according to example embodiments of the present invention effectively removes the ghost image on the sub display panel 630.

Having thus described example embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. A method of driving display panels in a multi display device, comprising:
A. driving a first display panel for a predetermined number of vertical synchronization pulses;
B. de-activating the first display panel after the predetermined number of vertical synchronization pulses; and
C. driving a second display panel to eliminate a ghost image thereon during step B.

2. The method of claim 1, wherein step B includes:
de-activating scan-lines coupled to the first display panel.

3. The method of claim 1, wherein each vertical synchronization pulse corresponds to a respective frame period.

4. The method of claim 3, wherein the second display panel is driven for one frame period after the predetermined number of vertical synchronization pulses.

5. The method of claim 4, wherein the second display panel is driven with one of a black image, a white image, a grey image, or a still image.

6. The method of claim 1, further comprising:
performing steps A, B, and C in response to external control signals provided to a display control circuit.

7. The method of claim 1, further comprising:
performing steps A, B, and C from counting the vertical synchronization pulses within a display control circuit.

8. The method of claim 1, wherein the de-activating the first display panel includes,
maintaining a common electrode voltage corresponding to a last vertical synchronization pulse of the predetermined number of vertical synchronization pulses during step B.

9. A multi display device comprising:
a first display panel;
a second display panel; and
a display control circuit for driving the first display panel for a predetermined number of vertical synchronization pulses, and having a ghost image elimination circuit for driving the second display panel to eliminate a ghost image thereon while de-activating the first display panel after the predetermined number of vertical synchronization pulses.

10. The multi display device of claim 9, further comprising:
first respective scan lines coupled to the first display panel from the display control circuit; and
second respective scan lines separate from the first respective scan lines and coupled to the second display panel from the display control circuit;
wherein the first respective scan lines are de-activated after the predetermined number of vertical synchronization pulses.

11. The multi display device of claim 10, further comprising:
source lines coupled to the first display panel with a sub-set of the source lines being shared with the second display panel.

12. The multi display device of claim 9, wherein each vertical synchronization pulse corresponds to a respective frame period.

13. The multi display device of claim 12, wherein the second display panel is driven for one frame period after the predetermined number of vertical synchronization pulses.

14. The multi display device of claim 13, wherein the second display panel is driven with one of a black image, a white image, a grey image, or a still image.

15. The multi display device of claim 9, wherein the display control circuit drives the second display panel after the predetermined number of vertical synchronization pulses in response to externally provided control signals.

16. The multi display device of claim 9, wherein the display control circuit drives the second display panel after the predetermined number of vertical synchronization pulses from counting the vertical synchronization pulses.

17. The multi display device of claim 9, wherein the display control circuit maintains a common electrode voltage corresponding to a last vertical synchronization pulse of the predetermined number of vertical synchronization pulses while the second display panel is driven.

18. The multi display device of claim 9, further comprising:
a common back-light shared between the first and second display panels.

19. The multi display device of claim 9, wherein the multi display device is part of a foldable mobile terminal with the first display panel being disposed on an inner surface of the foldable mobile terminal and with the second display panel being disposed on an outer surface of the foldable mobile terminal.

20. The multi display device of claim 19, wherein the display control circuit drives the first display panel for the predetermined number of vertical synchronization pulses and drives the second display panel to eliminate the ghost image after the predetermined number of vertical synchronization pulses when the mobile terminal is unfolded.
